(19) United States
(12) Patent Application Publication
(10) Pub. No.: US 2009/0089431 A1
(43) Pub. Date: Apr. 2, 2009

(54) System and method for managing resources in access network

(75) Inventors: Sun-me Kim, Daejeon-si (KR); You-hyeon Jeong, Daejeon-si (KR); Kyeong-ho Lee, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/157,593

(22) Filed: Jun. 11, 2008

(30) Foreign Application Priority Data
Sep. 28, 2007 (KR) 10-2007-0098236

(51) Int. Cl. G06F 15/173

(52) U.S. Cl. 709/226

(57) ABSTRACT

Disclosed are a system and a method for improved collection of resource information of an access network. The method includes obtaining line information about a line that a subscriber terminal in an access network accesses and resource information about at least a part of the line when an internet protocol (IP) is assigned to the subscriber terminal, transmitting the line information and the resource information from the access network, and creating a database containing the line information and the resource information. Thereby system load is reduced and efficiency of resource allocation is enhanced.

### CROSS REFERENCE TO RELATED APPLICATIONS

This application claims priority from Korean Patent Application No. 10-2007-0098236, filed on Sep. 28, 2007, the disclosure of which is incorporated herein in its entirety by reference.

### BACKGROUND OF THE INVENTION

1. Field of the Invention

The present invention relates to an access network, and more particularly to a technology for managing resources in an access network.

This work was supported by the IT R&D program of Ministry of Information and Communication (MIC)/Institute for Information Technology Advancement (IITA) [Subject No. 2005-S-097-03, Development of BcN integrated network control and QoS/TE management technology].

2. Description of the Related Art

An access network includes a subscriber terminal as a first level, a network termination device as a second level, a subscriber line concentrator as a third level, and a network access device as a fourth level. Since such a multilevel access network handles a large number of devices, inexpensive devices are used in building the multilevel access network to reduce costs. Further, according to time to complete new technology and time to apply the network, the access network is combined with various devices such as Ethernet, an Asymmetric Digital Subscriber Line (ADSL), an ADSL2, a Very high data rate Digital Subscriber Line (VDSL), a Passive Optical Network (PON), etc.

To manage the access network, an access network policy control server interlocks with the subscriber line concentrator and the network access device through a Simple Network Management Protocol (SNMP), and collects mass information relating to the device and the lines through an SNMP GET message, thereby compiling a database for managing resources of the access network. Such an information collection method is applicable to a high function and performance network access device capable of operating consistently without a technical variation.

However, when large numbers of subscriber line concentrators are present in the access network, the foregoing method of collecting and managing the information through SNMP places excessive system processing load upon the access network policy control server. In other words, the system processing load increases as the number of devices with which the access network policy control server has to interlock increases. Further, error generation/recovery and changes in the resources of the access network have to be managed in real-time, so that the function of the system is more complex.

Also, developments of interface technology are different according to ADSL, VDSL and Ethernet, and the kinds of Management Information Base (MIB) using the SNMP vary according to device manufacturers. If technological development continues at its present pace additional development and functional supplementation will be required for the MIB. Thus, a burden in development about managing the resources of the access network is increased and information accuracy is lowered.

Meanwhile, there is a demand for a multimedia Internet Protocol (IP) communication service such as Voice Over IP (VoIP), a Multi-Media over IP (MMoIP), Video on Demand (VoD), IP television (IPTV), etc. in an IP packet network, which is required to have quality equivalent to a circuit network. To secure the quality of the multimedia IP communication service, an end-to-end section service should be secured in the IP packet network. However, the quality of the multimedia IP communication service is not secured since it is impossible to control the service quality in the access network as described above.

### SUMMARY OF THE INVENTION

The present invention provides a method for collecting resource information of an access network, thereby decreasing system load and enhancing efficiency in resource allocation.

The present invention also provides a method for securing the quality of a multimedia call service.

Additional aspects of the invention will be set forth in the description which follows, and in part will be apparent from the description, or may be learned by practice of the invention.

The present invention discloses a resource management method including: obtaining line information about a line accessed by a subscriber terminal in an access network and resource information about at least a part of the line when an Internet Protocol (IP) is assigned to the subscriber terminal; transmitting the line information and the resource information from the access network; and creating a database containing the line information and the resource information.

The obtaining of the line information and the resource information may include: obtaining line information about a part of a line accessed by the subscriber terminal; and obtaining resource information about the part of the line.

The present invention also discloses a resource management system including: a subscriber line concentrator connected to a plurality of network termination devices to serve as a Dynamic Host Configuration Protocol (DHCP) relay agent when assigning an Internet Protocol (IP) to a subscriber terminal, and to obtain line information about a line accessed by the subscriber terminal and upstream and downstream capacity information about the line; a network access device connected to a plurality of subscriber line concentrators to transmit access line information of the subscriber line concentrator from an access network in addition to the line information, the upstream capacity information, and the downstream capacity information which are obtained by the subscriber line concentrator; and a resource management server creating a database with the line information, the upstream capacity information and the downstream capacity information which are transmitted from the network access device.

The subscriber line concentrator may transmit information about the access line of the subscriber terminal and information about the upstream and downstream capacity corresponding to the access line to a network access device on the basis of a DHCP relay agent option; the network access device may extract the information about the access line of the subscriber terminal and the information about the upstream and downstream capacity corresponding to the access line from the DHCP relay agent option, and add the extracted information to a separate packet along with information about the access line of the subscriber line concentrator, the packet being transmitted to the resource management server; and the network access device may create a database using the line information and the upstream and downstream capacity information from the received packet.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a schematic diagram of a network according to an exemplary embodiment of the present invention.

FIG. 2 shows a resource management method according to an exemplary embodiment of the present invention.

FIG. 3 shows a relay agent option 82 for a Dynamic Host Configuration Protocol (DHCP) according to an exemplary embodiment of the present invention.

FIG. 4 is a flowchart showing a function of a DHCP relay agent of a subscriber line concentrator according to an exemplary embodiment of the present invention.

FIG. 5 is a flowchart showing a network access device receiving a DHCP packet and serving as an AAA client according to an exemplary embodiment of the present invention.

FIG. 6 is a conceptual table relating to a subscriber access authentication.

FIG. 7 is a conceptual table relating to a level resource of the subscriber line concentrator.

FIG. 8 is a conceptual table relating to a level resource of a network termination device.

FIG. 9 is a flowchart of authenticating a resource management server and creating a database according to an exemplary embodiment of the present invention.

FIG. 10 shows a process of setting up a multimedia call.

FIG. 11 shows a process of releasing the multimedia call.

FIG. 12 is a flowchart showing that the resource management server checks resource availability and allocates resources according to an exemplary embodiment of the present invention.

FIG. 13 is a flowchart showing that the resource management server releases the resource allocation according to an exemplary embodiment of the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as being limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

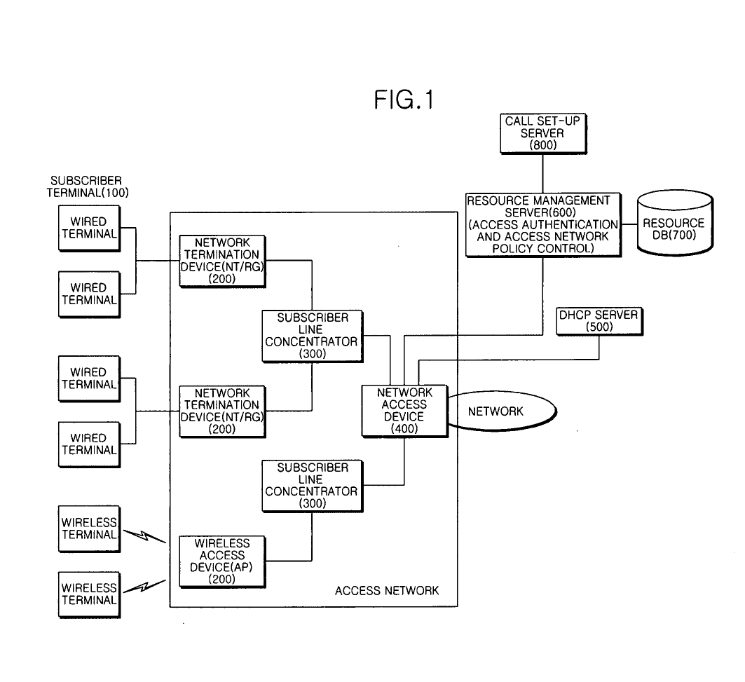

FIG. 1 is a schematic diagram of a network according to an exemplary embodiment of the present invention.

A subscriber terminal 100 may be a wired or wireless terminal. The wired terminal includes an in-home terminal such as a set-top box, a Voice over Internet Protocol (VoIP) phone, etc. The wireless terminal includes an in-home and portable terminal such as a Personal Computer (PC), a Personal Digital Assistant (PDA), etc., which can access a network through a wireless communication interface, e.g., a wireless fidelity (WiFi) interface. The subscriber terminal 100 accesses a subscriber line concentrator 300 via a network termination device 200 such as a modem or a home gateway and via a wireless access device such as an access point (AP).

The subscriber line concentrator 300 includes an Ethernet switch, a Digital Subscriber Line Access Multiplexer (DSLAM) for an Asymmetric Digital Subscriber Line (ADSL), a Very high data rate Digital Subscriber Line (VDSL), or the like. The subscriber line concentrator 300 provides access to the subscriber terminal, and concentrates and sends traffic from the subscriber terminal 100 to the network. For this purpose, the subscriber line concentrator 300 is connected to the network access device 400 described below. Also, the subscriber line concentrator 300 serves as a Dynamic Host Configuration Protocol (DHCP) relay agent when processing DHCP.

The network access device 400 is connected to a device functioning as a Broadband Remote Access Server (BRAS) that performs subscriber management, IP assignment, and a subscriber service offer. According to an exemplary embodiment of the present invention, the network access device 400 functions as a DHCP proxy or relay, and also serves as an AAA client for authentication.

Herein, the network termination device 200, the subscriber line concentrator 300, and the network access device 400 are referred to as an access network. The access network performs IP assignment and service control so that the subscriber terminal 100 can access and communicate with the network through various interfaces. Further, the access network sends the traffic from the subscriber terminal 100 to the network, and vice versa.

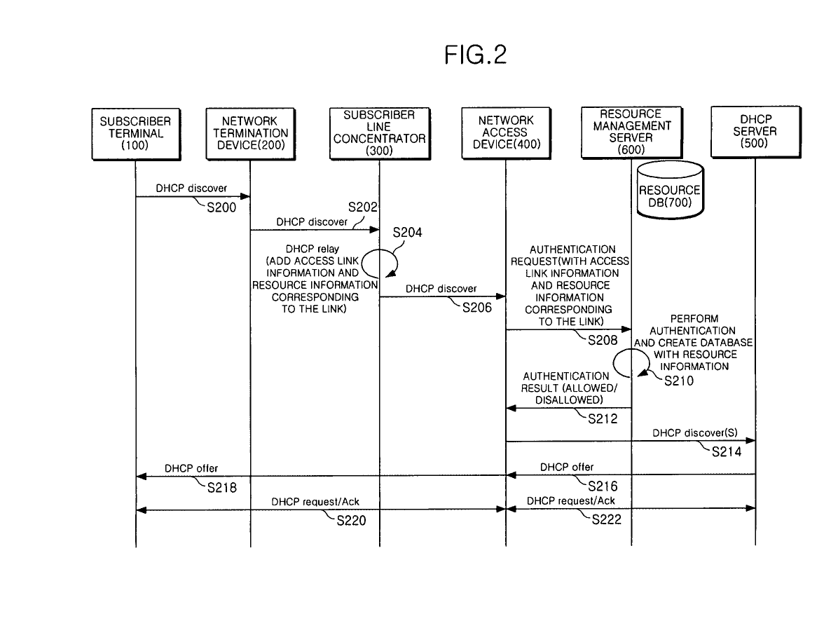

In the meantime, function and interlock between elements of a data transport layer and elements of a control layer are needed to provide the subscriber terminal 100 with access to the access network and to allow the subscriber terminal 100 to receive the communication service. First, a DHCP server 500 is needed to assign the IP to the subscriber terminal 100. Also, an access network policy control server is needed for authentication to determine whether the subscriber is allowed to access the network or not; to manage of the access network; and to check resource state and availability with regard to a multimedia call of the subscriber. Access authentication and access network policy control may be performed in a single system or in separate systems. In FIG. 2, such a configuration is defined as being supported by a resource management server 600. However, this configuration need not be realized by means of a single physical server, and several servers may be provided for performing individual functions.

According to an aspect of the present invention, the resource management server 600 creates a resource database (DB) 700 for the access network. The resource management server 600 and the resource (DB) 700 may take the form of a single server or multiple servers. This configuration is not related to the subject matter of the present invention.

A call set-up server 800 provides multimedia calling capabilities such as VoIP/MMoIP, VoD, or the like according to requests from the subscriber terminal 100 accessing a packet network. The call set-up server 800 has to check the resource availability of the resource management server 600 so as to determine whether service quality is securable in an end-to-end section. The call set-up server 800 controls acceptance of the multimedia call after checking availability and allocating resources.

FIG. 2 shows a resource management method according to an exemplary embodiment of the present invention.

When the subscriber terminal 100 performs a DHCP process while trying to access the network at operation S200, a DHCP discover packet is received in a certain access interface port of the subscriber line concentrator 300 via the network termination device 200 at operation S202. The subscriber line concentrator 300 serves as a DHCP relay, i.e., adds information about circuit identification (ID) of the subscriber terminal 100, and upstream and downstream capacity of the access line to a DHCP relay agent option 82 at operation S204. The DHCP packet, for which the DHCP relay agent option is processed, is relayed and sent to the network access device 400 at operation S206.

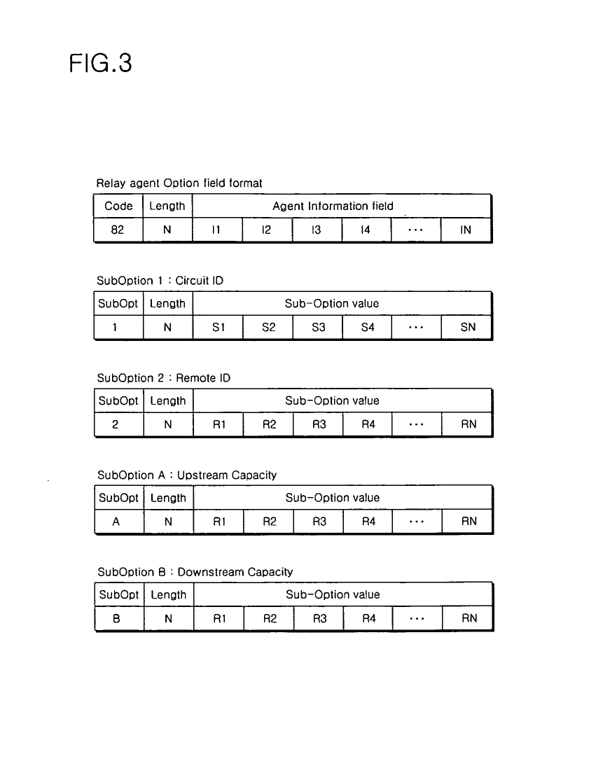

FIG. 3 shows a relay agent option 82 for a dynamic host configuration protocol (DHCP) according to an exemplary embodiment of the present invention.

In a relay agent option field format, an agent information field is defined in the same format as a sub option field. Here, Sub Option 1 and Sub Option 2 are known in the art, but Sub Option A and Sub Option B are newly defined according to an exemplary embodiment of the present invention. Information about the access line of the subscriber terminal 100 is written in Sub Option 1. Usually, the information is written as a common subscriber access interface identifier. In Sub Option 2, additional information may be written if necessary. Likewise, upstream capacity information about the access line of the subscriber terminal 100 is written in Sub Option A, and downstream capacity information is written in Sub Option B. Here, it will be assumed that ‘A’ and ‘B’ are arbitrarily set numbers, respectively. These numbers may be defined during standardization.

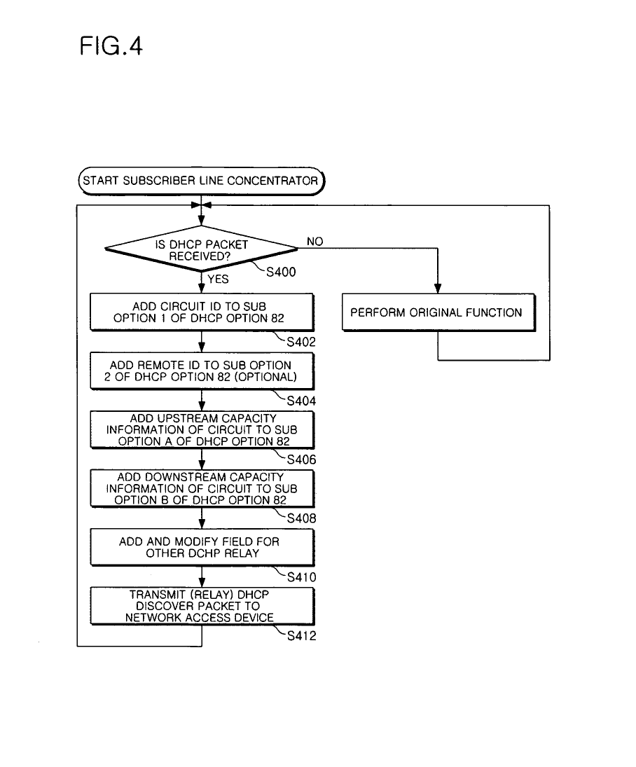

FIG. 4 is a flowchart showing a function of a DHCP relay agent of a subscriber line concentrator according to an exemplary embodiment of the present invention. The subscriber line concentrator 300 functioning as the DHCP relay detects whether or not a DHCP packet is received. When the DHCP packet is received at operation S400, the circuit ID for identifying a received port is added to Sub Option 1 of the DHCP relay agent option 82 at operation S402. Here, the circuit ID is information about the access line, i.e., information about a line between the network termination device 200 and the subscriber line concentrator 300.

If it is possible to selectively identify an address of the subscriber terminal 100 or the network termination device 200 that transmits the packet, relevant information is added to a remote ID of Sub Option 2 at operation S404. Further, the upstream/downstream capacities of the line through which the DHCP packet is received are retrieved from system information in real time, and then written in Sub Options A and B at operations S406 and S408, respectively. Another DHCP relay agent adjusts fields in need of modification and addition at operation S410, and then relays the DHCP packet to the network access device 400 at operation S412.

Referring to FIG. 2 again, the network access device 400 extracts information about the circuit ID of the subscriber terminal 100, the upstream capacity, and the downstream capacity from the received DHCP packet, and writes the information in an authentication request packet along with additional line information, thereby transmitting an authentication request to the resource management server 600 at operation S208. Here, the additional line information is line information between the subscriber line concentrator 300 and the network access device 400, i.e., may be a circuit ID corresponding to the received port. Further, the authentication request may use various AAA protocols such as a radius, a diameter, and the like. Also, an information writing field of a request packet may be consistently defined under an agreement between interlocking devices. If the authentication is successful, the DHCP process is completed and thus an IP is assigned to the subscriber terminal 100.

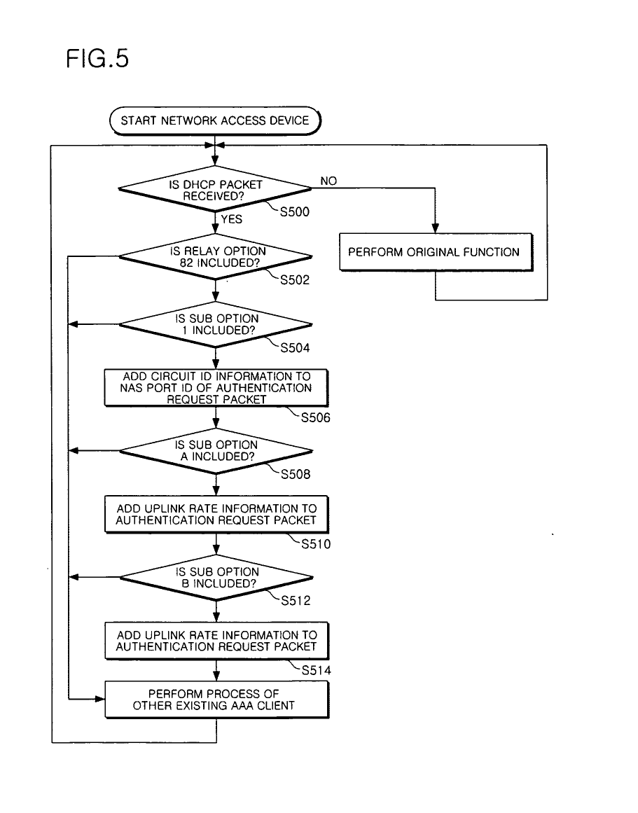

FIG. 5 is a flowchart showing a network access device receiving a DHCP packet and operating as an AAA client according to an exemplary embodiment of the present invention.

The network access device 400 checks whether the DHCP packet is received or not at operation S500, and checks whether the received DHCP packet includes the relay agent option 82 and its respective sub option information at operation S502. If the received DHCP packet includes the circuit ID of Sub Option 1, the network access device 400 writes the following information in a NAS port ID field of the authentication request field at operations S504 and S506.
In asynchronous transfer mode (ATM)
:slot number/port number atm [vpi number [vci number]]
In a virtual local area network (VLAN)
: slot number/port number vlan-id [tunl-vlan [srv-vlan]]

Here, the slot/port numbers are port numbers of the network access device that receives the packet. The vpi/vci numbers in the ATM and the tunl-vlan and srv-vlan numbers in the VLAN are information extracted from the circuit ID.

If upstream capacity information is in Sub Option A, the upstream capacity information is written in a defined field of the authentication request packet at operations S508 and S510. If downstream capacity information is in Sub Option B, the downstream capacity information is written in a defined field of the authentication request packet at operations S512 and S514.

The kind of authentication request packet may vary according to whether the AAA protocol is the radius or the diameter. Further, the upstream capacity information writing field and the downstream capacity information writing field may be usable by defining the identifier and the format under the agreement with the AAA protocol.

Meanwhile, the resource management server 600 receives the authentication request packet from the network access device 400, authenticates the accessing subscriber terminal 100, returns the authentication result to the network access device 400, and extracts the circuit ID and the upstream and downstream capacity information, thereby creating the resource database 700 at operation S210.

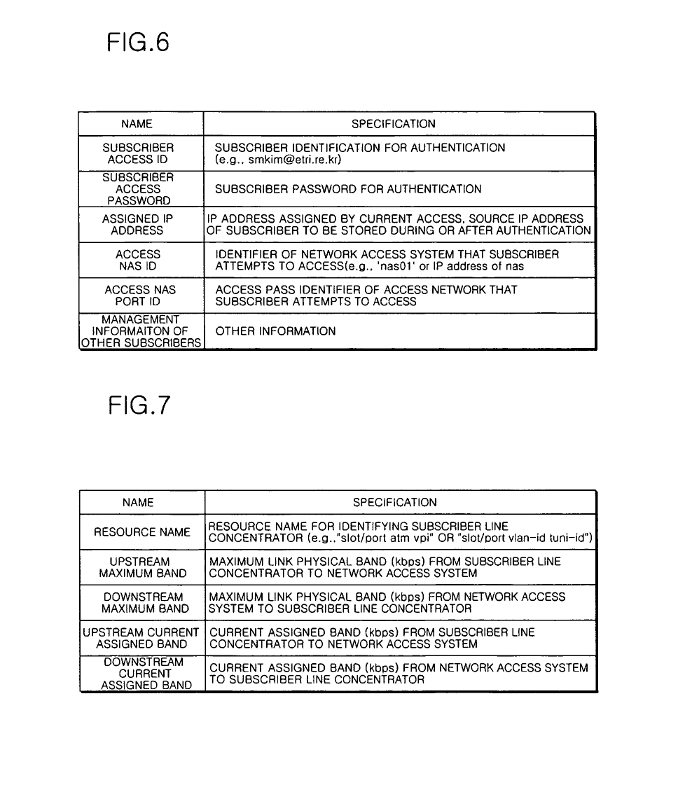

FIG. 6 is a conceptual table relating to subscriber access authentication.

The table for the subscriber access authentication is extracted from the authentication request packet, and contains a subscriber access ID, a subscriber access password, an access NAS ID corresponding to the network access device 400, a port of the network access device 400 connected with the subscriber line concentrator 300, an access NAS ID corresponding to an access interface of the subscriber line concentrator 300, an IP address assigned to the subscriber, and other relevant information.

FIG. 7 is a conceptual table relating to a level resource of the subscriber line concentrator.

The table for the level resource of the subscriber line concentrator 300 manages the line resource information in a section between the network access device 400 and the subscriber line concentrator 300 among lines that the subscriber tries to access. In ATM, the table contains a resource name in the format of ‘slot/port atm vpi,’ upstream and downstream maximum bandwidth information, and upstream and downstream current assigned bandwidth information fields. In VLAN, the table contains a resource name in the format of ‘slot/port vlan-id tunl-id,’ upstream and downstream maximum bandwidth information, and upstream and downstream current assigned bandwidth information fields. Here, the upstream and downstream maximum bandwidth information may be collected through the SNMP, or dynamically collected from the network access method 400 by other methods. Further, the upstream and downstream current assigned bandwidth indicates the amount of resources assigned by the call set-up server 800 with respect to the multimedia call.

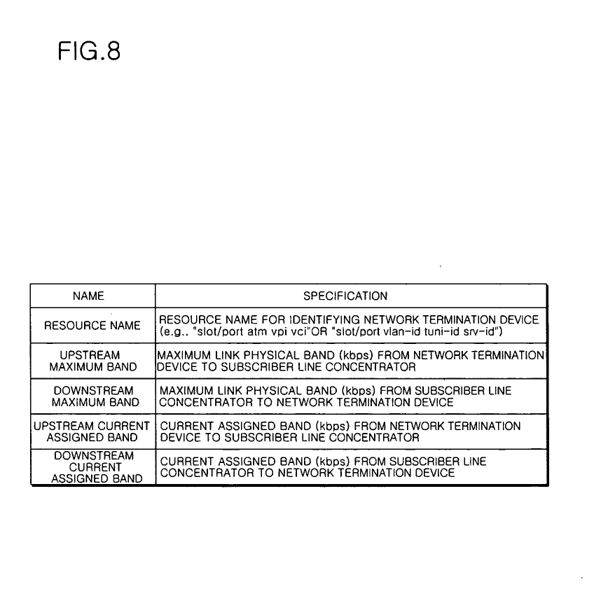

FIG. 8 is a conceptual table relating to a level resource of a network termination device.

The table for the level resource of the network termination device manages the line resource information in a section between the network termination device 200 and the subscriber line concentrator 300 among lines that the subscriber terminal 100 tries to access. In the ATM, the table contains a resource name in the format of ‘slot/port atm vpi,’ upstream and downstream maximum bandwidth information, and upstream and downstream current assigned bandwidth information fields. In the VLAN, the table contains a resource name in the format of ‘slot/port vlan-id tunl-id,’ upstream and downstream maximum bandwidth information, and upstream and downstream current assigned bandwidth information fields. Here, the upstream and downstream maximum bandwidth information may be collected from Sub Options A and B of the relay option by the DHCP relay agent.

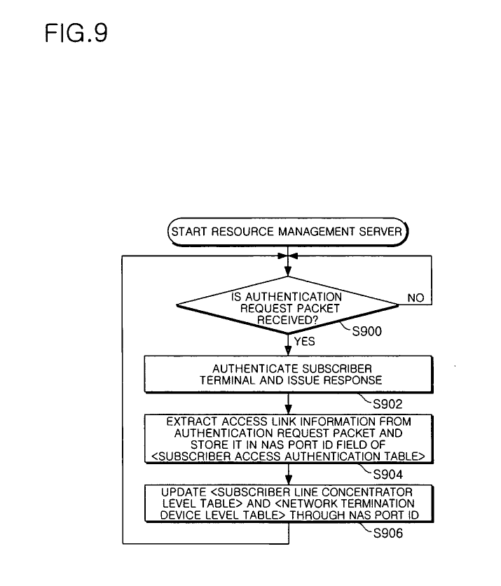

FIG. 9 is a flowchart illustrating authentication of resource management server and creation of a database according to an exemplary embodiment of the present invention.

When receiving the authentication request packet from the network access device 400 at operation S900, the resource management server 600 performs a typical authentication process to form a response at operation S902, and then extracts information about the line that the subscriber terminal 100 accesses from the authentication request packet, thereby storing the extracted information in the NAS Port ID field of the <table for the subscriber access authentication> at operation S904. Further, the resource management server 600 creates entries of the <subscriber line concentrator level table> corresponding to the section between the network access device 400 and the subscriber line concentrator 300 and the <network termination device level table> corresponding to the section between the network termination device 200 and the subscriber line concentrator 300 on the basis of the NAS port ID, and updates the upstream and downstream maximum assigned bandwidth information on the basis of the upstream and downstream capacity information at operation S906.

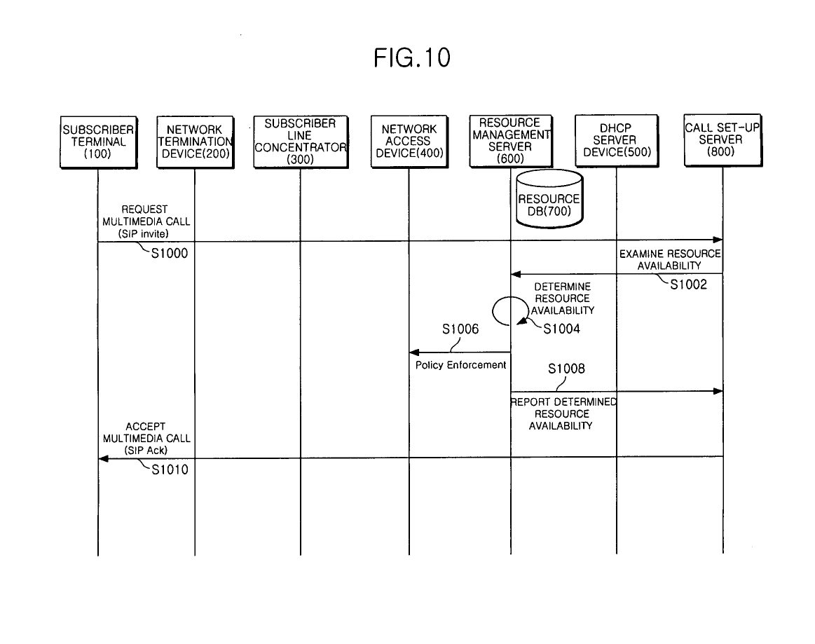

FIG. 10 shows a process of setting up a multimedia call.

The subscriber terminal 100 requests that the call set-up server 800 set up the multimedia call through a signaling process such as an SIP invite at operation S1000. When receiving the request, the call set-up server 800 examines the availability of the resource in the end-to-end section. In other words, to examine the availability of the access network section, the call set-up server 800 asks the resource management server 600 whether resources are available for the call of the subscriber terminal 100 at operation S1002.

In response to the request for resource availability, the resource management server 600 locates the subscriber terminal 100 in the <subscriber access authentication table> on the basis of a source IP address corresponding to the requested call, and looks up the entries of the <subscriber line concentrator level table> and <network termination device level table> by retrieving the NAS port ID that the subscriber accesses. If a band excluding the currently assigned band from the maximum band is available for the requested band with regard to the upstream and downstream, the resource is allocated to the band at operation S1004. Further, with respect to the allocated resource, the network access device 400 is requested to apply QoS policy needed for setting up the network at operation S1006, and then the process results of the resource availability are sent to the call set-up server 800 at operation S1008.

The call set-up server 800 applies the same resource-availability examination to the other access network and an edge-to-edge section. If all resources of the end-to-end section are available, the call set-up server 800 accepts the call set-up requested by the subscriber terminal 100 at operation S1010.

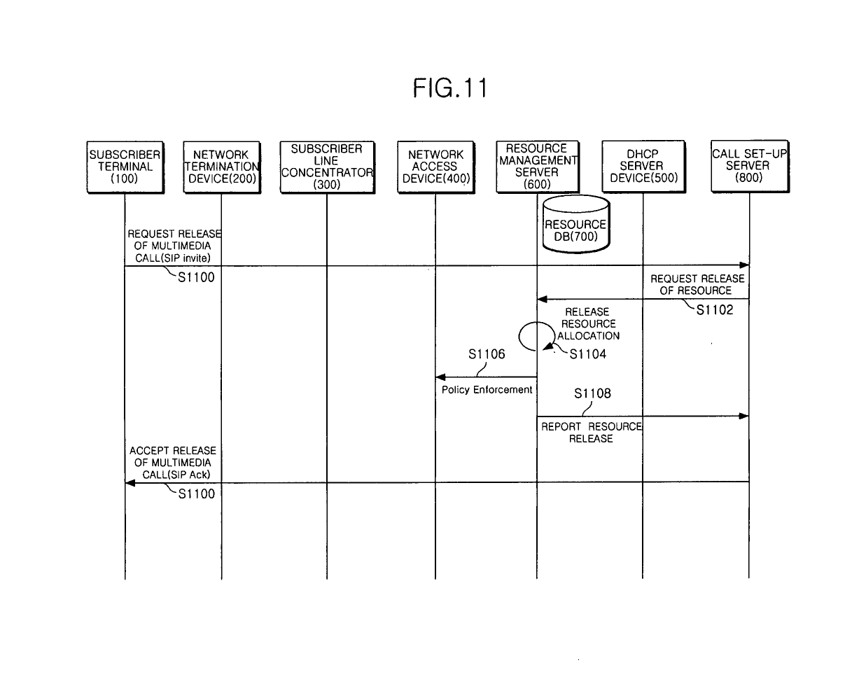

FIG. 11 shows a process of releasing the multimedia call.

The subscriber terminal 100 requests that the call set-up server 800 release the multimedia call through a signaling process such as an SIP invite at operation S100. The call set-up server 800 requests that the resource management server 600 release the resource at operation S1102, and then the resource management server 600 locates the access line where the call is set up, thereby releasing the resource from the assignment at operation S1104. Further, the QoS policy set up by the network access device 400 is released at operation S1106, and the release result is sent to the call set-up server 800 at operation S1108. Thus, the call set-up server 800 sends ‘SIP Ack’ to acknowledge the call release to the subscriber terminal 100.

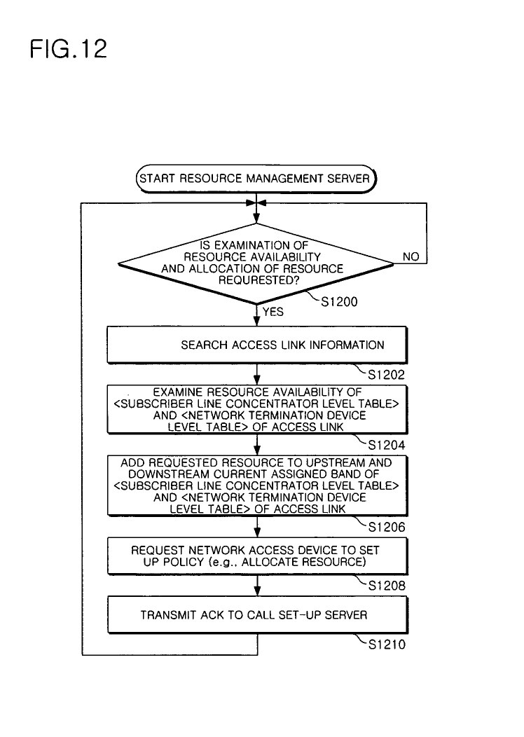

FIG. 12 is a flowchart showing the resource management server checking resource availability and allocating resources according to an exemplary embodiment of the present invention.

In response to the request to examine the resource availability and allocate the resource from the call set-up server 800 at operation S1200, the resource management server 600 locates the circuit ID of the subscriber terminal 100, which requests the resource allocation, in the <subscriber access authentication table> on the basis of the source IP address at operation S1202. Using the located NAS port ID, the resource availability of the <subscriber line concentrator level table> and the <network termination device level table> is examined at operation S1204, and the requested resource is added to the resource allocation of each table if the resource is available in all levels of the access network at operation S1206. Further, the BRAS, i.e., the network access device 400 is requested to properly set up the QoS policy, so that the service quality of the subscriber terminal 100 can be secured at operation S1208. If the resource is available, the resource management server 600 gives a response of ‘Ack’ to the call set-up server 800, and if the resource is unavailable, the resource management server 600 gives a response of ‘Nack’ to the call set-up server 800 at operation S1210.

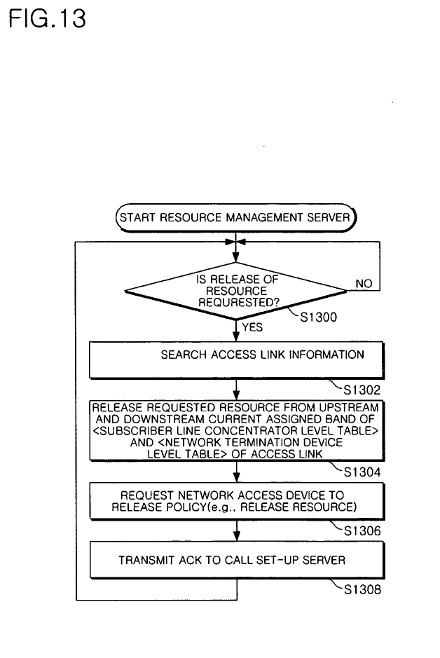

FIG. 13 is a flowchart showing the resource management server releasing the resource allocation according to an exemplary embodiment of the present invention.

When the call set-up server 800 requests that the resource management server 600 release the resource allocated to the call of the subscriber terminal 100 as the subscriber terminal 100 finishes the multimedia call at operation S1300, the resource management server 600 detects the circuit ID of the subscriber terminal 100 in the <subscriber access authentication table> on the basis of the source IP address at operation S1302. Then, the resource management server 600 releases the requested resources from the allocated resources of the <subscriber line concentrator level table> and the <network termination device level table> on the basis of the detected information at operation S1304. Further, the network access device 400 is requested to release the QoS policy applied to data communication, and the resource management server 600 gives a response of ‘Ack’ to the call set-up server 800 at operations S1306 and S1308.

The present invention proposes a method for creating and managing a database by automatically detecting real-time topology information and upstream/downstream resource capacity information about a resource line of an access network connecting with a subscriber terminal when the subscriber terminal tries to access the network through a dynamic host configuration protocol (DHCP) and receives authentication, thereby decreasing a system load and enhancing efficiency in resource allocation. Thereby it is also possible to secure a high quality multimedia communication service.

Further, since the resource is collected and managed when allocating internet protocol (IP), change of access location is checked in real time even if the access location of a subscriber has changed, so that it is possible to manage the resource.

Although the present invention has been described with reference to the embodiments and the accompanying drawings, it is not limited to the embodiments and the drawings. It should be understood that various modifications and changes can be made by those skilled in the art without departing from the spirit and scope of the present invention defined by the accompanying claims.

What is claimed is:

1. A resource management method comprising:
obtaining line information about a line accessed by a subscriber terminal in an access network and resource information about at least a part of the line when an Internet Protocol (IP) is assigned to the subscriber terminal;
transmitting the line information and the resource information from the access network; and
creating a database containing the line information and the resource information.

2. The resource management method according to claim 1, wherein the obtaining of the line information and the resource information comprises:
obtaining line information about a part of a line accessed by the subscriber terminal; and
obtaining resource information about the part of the line.

3. The resource management method according to claim 2, wherein the resource information comprises information about upstream and downstream capacity on the part of the line.

4. The resource management method according to claim 3, wherein in the obtaining of line information about a part of a line accessed by the subscriber terminal, a subscriber line concentrator, which constitutes the access network and serves as a Dynamic Host Configuration Protocol (DHCP) relay agent during the IP allocation, checks information about an access port of the subscriber terminal to the subscriber line concentrator to obtain the information about the line accessed by the subscriber terminal.

5. The resource management method according to claim 4, wherein the obtaining of resource information about the part of the line is performed by the subscriber line concentrator.

6. The resource management method according to claim 5, wherein the line and the resource information are about a section for a network termination device and the subscriber line concentrator in the access network.

7. The resource management method according to claim 5, wherein the transmitting of the line information and the resource information comprises:
transmitting to a network access device, by the subscriber line concentrator, information about the line accessed by the subscriber terminal and information about upstream and downstream capacity of the access line on the basis of a DHCP relay agent option;
extracting, by the network access device, the information about the access line of the subscriber terminal and the information about the upstream and downstream capacity corresponding to the access line from the DHCP relay agent option; and
writing into a packet, by the network access device, the upstream and downstream capacity information and line identification information for line information about a section of the network access device and the subscriber line concentrator in addition to the extracted access line information, and transmitting the packet from the access network.

8. The resource management method according to claim 7, wherein in the transmitting to a network access device, the subscriber line concentrator writes access line information in a sub option 1 circuit ID among agent information fields of a DHCP relay agent option 82, writes the upstream and downstream capacity information in two newly defined sub options, and transmits the written information to the network access device.

9. The resource management method according to claim 7, wherein in the creating of a database containing the line information and the resource information, a resource management server, which is located outside the access network and receives the packet, extracts the line identification information, the upstream capacity information and the downstream capacity information from the packet, and creates a database containing the extracted information.

10. The resource management method according to claim 9, wherein the resource management server receives an authentication request packet and authenticates the subscriber terminal.

11. A resource management system comprising:
a subscriber line concentrator connected to a plurality of network termination devices to serve as a Dynamic Host Configuration Protocol (DHCP) relay agent when assigning an Internet Protocol (IP) to a subscriber terminal, and to obtain line information about a line accessed by the subscriber terminal and upstream and downstream capacity information about the line;
a network access device connected to a plurality of subscriber line concentrators to transmit access line information of the subscriber line concentrator from an access network in addition to the line information, the upstream capacity information, and the downstream capacity information which are obtained by the subscriber line concentrator; and
a resource management server creating a database with the line information, the upstream capacity information and the downstream capacity information which are transmitted from the network access device.

12. The resource management system according to claim 11,
wherein the subscriber line concentrator transmits information about the access line of the subscriber terminal and information about the upstream and downstream capacity corresponding to the access line to a network access device on the basis of a DHCP relay agent option;
wherein the network access device extracts the information about the access line of the subscriber terminal and the information about the upstream and downstream capacity corresponding to the access line from the DHCP relay agent option, and adds the extracted information to a separate packet along with information about the access line of the subscriber line concentrator, the packet being transmitted to the resource management server; and
wherein the network access device creates a database using the line information and the upstream and downstream capacity information from the received packet.

13. The resource management system according to claim 12, wherein the subscriber line concentrator writes access line information in a sub option 1 circuit ID among agent information fields of a DHCP relay agent option 82, writes the upstream and downstream capacity information in two newly defined sub options, and transmits the written information to the network access device.

14. The resource management system according to claim 13, wherein the packet comprises an authentication request packet for an IP assignment, and the resource management server authenticates the IP assignment of the subscriber terminal separately from creating the database.

15. The resource management system according to claim 14, further comprising:
a call set-up server for setting up a call according to a multimedia call of a subscriber,
wherein the resource management server checks resource availability of the access network on the basis of the database, and allocates resources according to checked results to enable call set-up.
